(19) United States
(12) Patent Application Publication
(10) Pub. No.: US 2025/0002348 A1
(43) Pub. Date: Jan. 2, 2025

(54) CARBON NANOTUBE COMPOSITION, CATALYST FOR MANUFACTURING CARBON NANOTUBES, METHOD OF MANUFACTURING CARBON NANOTUBES, AND CARBON NANOTUBES

(71) Applicant: TOHOKU UNIVERSITY, Sendai-shi, Miyagi (JP)

(72) Inventors: Toshiaki KATO, Sendai-shi (JP); Toshiro KANEKO, Sendai-shi (JP)

(21) Appl. No.: 18/695,134

(22) PCT Filed: Sep. 27, 2022
(86) PCT No.: PCT/JP2022/035872

§ 371 Date: Mar. 25, 2024

(30) Foreign Application Priority Data
Sep. 28, 2021 (WO) PCT/JP2021/035526

(51) Int. Cl. C01B 32/159; B01J 23/843; B82Y 40/00; C01B 32/162

(52) U.S. Cl. CPC C01B 32/159; B01J 23/8435; B82Y 40/00; C01B 32/162; C01B 2202/02; C01B 2202/30; C01P 2004/13; C01P 2006/40; C01P 2006/80

(57) ABSTRACT

An object of the present invention is to provide a carbon nanotube composition including carbon nanotubes having semiconductivity and a highly uniform chirality characteristic; a catalyst for manufacturing carbon nanotubes capable of producing carbon nanotubes having semiconductivity and a highly uniform chirality characteristic; a method of manufacturing carbon nanotubes using the catalyst; and carbon nanotubes manufactured by using the manufacturing method. The carbon nanotube composition of the present invention includes a metal and a carbon nanotube. The metal contains Ni, and both or at least one of Sn and/or Sb, and the carbon nanotube is a single-walled body and has semiconductivity.

### CROSS-REFERENCE TO RELATED APPLICATIONS

This application is the U.S. National Stage entry of International Application No. PCT/JP2022/035872, filed on Sep. 27, 20212, which claims priority to PCT/JP2021/035526, filed on Sep. 28, 2021, both of which are incorporated herein by reference in their entirety for all purposes.

### TECHNICAL FIELD

The present invention relates to a carbon nanotube composition, a catalyst for manufacturing carbon nanotubes, a method of manufacturing carbon nanotubes, and carbon nanotubes.

### BACKGROUND ART

Single-walled carbon nanotube is a substance having a structure in which one graphene sheet composed of six membered carbon rings is rolled into a cylindrical shape. It is known that, in single-walled carbon nanotubes, a characteristic as to whether an electronic state is metallic or semiconductive is determined based on a rolling manner (chirality) in an axial direction of graphene. Semiconductive single-walled carbon nanotubes have attracted attention as, for example, materials for transistors and sensors, and coating type semiconductor materials for RFID (radio frequency identifier) tags.

As methods for controlling the characteristics of single-walled carbon nanotubes, a template growth method, a separation method, and a chemical vapor deposition method (CVD method) are known. The template growth method is a method of newly growing nanotubes using a tip (cap) portion or a partially cut fine structure of carbon nanotubes as a template. The separation method is a method of chemically separating carbon nanotubes into metallic carbon nanotubes and semiconductive carbon nanotubes using a separating agent (Patent Document 1). The chemical vapor deposition method (CVD method) is a method in which a raw material gas is supplied to deposit carbon nanotubes on a catalyst (nucleus) (Patent Document 2). Patent Document 2 describes use of metal fine particles as a catalyst, the metal fine particles being formed by placing a base material on which metal ions and ruthenium ions are laid in a synthesis furnace and heating the base material under reducing conditions.

### CITATION LIST

### Patent Document

Patent Document 1: JP 2021-80121 A
Patent Document 2: JP 2015-93807 A

### SUMMARY OF INVENTION

### Technical Problem

The template growth method is difficult to increase yield. In the separation method, the separating agent tends to remain in the single-walled nanotubes after separation, and it is difficult to stabilize quality. In the CVD method, it is difficult to make chirality characteristics of the obtained carbon nanotubes uniform.

The present invention has been made in view of the above issues, and an object thereof is to provide a carbon nanotube composition including carbon nanotubes having semiconductivity and a highly uniform chirality characteristic: a catalyst for manufacturing carbon nanotubes capable of producing carbon nanotubes having semiconductivity and a highly uniform chirality characteristic; a method of manufacturing carbon nanotubes using the catalyst; and carbon nanotubes manufactured using the manufacturing method.

### Solution to Problem

The present inventors have found that with use of alloy particles containing Ni and at least one of Sn or Sb as a catalyst, carbon nanotubes having semiconductivity and a highly uniform chirality characteristic can be produced by heating a carbon source in the presence of the catalyst, and have completed the present invention.

Accordingly, the present invention has the following aspects:

[1] A carbon nanotube composition including a metal and a carbon nanotube, the metal containing Ni, and both or one of Sn and/or Sb, the carbon nanotube being a single-walled body and having semiconductivity.

[2] The carbon nanotube composition according to [1], wherein the metal is present in a form of particles, and at least one end of the ends of the carbon nanotube is adhered to a surface of the particles.

[3] The carbon nanotube composition according to [1] or [2], including 1 mass ppm or more of Ni, and 1 mass ppm or more of both or one of Sn and/or Sb.

[4] The carbon nanotube composition according to [1] or [2], wherein the carbon nanotube includes a (6.5) chirality carbon nanotube, and the (6.5) chirality carbon nanotube has a purity of 60% or more.

[5] The carbon nanotube composition according to [1] or [2], wherein the carbon nanotube includes a (8.7) chirality carbon nanotube, and the (8.7) chirality carbon nanotube has a purity of 60% or more.

[6] The carbon nanotube composition according to [1] or [2], wherein the carbon nanotube includes a (7.5) chirality carbon nanotube, and the (7.5) chirality carbon nanotube has a purity of 60% or more.

[7] A catalyst for manufacturing carbon nanotubes, the catalyst including alloy particles containing Ni, and both or one of Sn and/or Sb.

[8] The catalyst for manufacturing carbon nanotubes according to [7], wherein Ni content with respect to 1 part by mass of total content of Sn and Sb in the alloy particles is in a range of 0.5 parts by mass or more and 10.0 parts by mass or less.

[9] The catalyst for manufacturing carbon nanotubes according to [7] or [8], wherein the alloy particles further contain Fe.

[10] The catalyst for manufacturing carbon nanotubes according to [9], wherein Fe content with respect to 1 part by mass of total content of Sn and Sb in the alloy particles is in a range of 0.1 parts by mass or more and 5.0 parts by mass or less.

[11] The catalyst for manufacturing carbon nanotubes according to [7] or [8], wherein the alloy particles are supported on porous particles.

[12] A method of manufacturing carbon nanotubes, the method including: a preparation step of preparing a catalyst containing Ni, and both or one of Sn and/or Sb; and a production step of producing carbon nanotubes by heating a carbon source in a presence of the catalyst.

[13] The method of manufacturing carbon nanotubes according to [12], wherein, in the production step, a heating temperature when the carbon source is heated in the presence of the catalyst is 650° C. or lower.

[14] The method of manufacturing carbon nanotubes according to [12], wherein, in the production step, a heating temperature when the carbon source is heated in the presence of the catalyst is 700° C. or higher and 750° C. or lower.

[15] The method of manufacturing carbon nanotubes according to [12], further including, after the preparation step and before the production step, an annealing step of annealing the carbon source in the presence of the catalyst.

[16] The method of manufacturing carbon nanotubes according to [12], wherein, in the production step, the carbon source is a carbon-containing gas, and the carbon-containing gas is converted into plasma and brought into contact with the catalyst.

[17] The method of manufacturing carbon nanotubes according to [12], wherein, in the production step, the carbon nanotubes are produced by heating the carbon source in the presence of the catalyst and porous particles.

[18] A carbon nanotube obtained by the method described in [12].

### Advantageous Effects of Invention

According to the present invention, it is possible to provide a carbon nanotube composition including carbon nanotubes having semiconductivity and a highly uniform chirality characteristic. In addition, according to the present invention, it is possible to provide a catalyst for manufacturing carbon nanotubes capable of producing carbon nanotubes having semiconductivity and a highly uniform chirality characteristic, a method of manufacturing carbon nanotubes using the catalyst, and carbon nanotubes manufactured using the manufacturing method.

### BRIEF DESCRIPTION OF DRAWINGS

FIG. 1A is a fluorescence emission spectrum indicating the relationship between a wavelength of excitation light applied to a carbon nanotube composition obtained in Example 1 and intensity of fluorescence at a wavelength of 970 nm generated by application of the excitation light.

FIG. 1B is a three-dimensional fluorescence spectrum indicating the relationship between the wavelength of excitation light applied to the carbon nanotube composition obtained in Example 1 and a wavelength and intensity of fluorescence generated by application of the excitation light.

FIG. 2 is a configuration diagram of an example of a plasma CVD apparatus that can be used in a method of manufacturing carbon nanotubes of the present embodiments.

FIG. 3 is a conceptual diagram indicating a structure of metal particles contained in a carbon nanotube composition obtained in Example 2.

FIG. 4 is an X-ray photoelectron spectroscopic spectrum of the carbon nanotube composition obtained in Example 2.

FIG. 5 is a three-dimensional fluorescence spectrum indicating the relationship between the wavelength of excitation light applied to a carbon nanotube composition obtained in Example 10 and a wavelength and intensity of fluorescence generated by application of the excitation light.

FIGS. 6(a) to 6(f) are three-dimensional fluorescence spectra indicating the relationship between the wavelength of excitation light applied to carbon nanotube compositions obtained in Examples 11 to 16 and a wavelength and intensity of fluorescence generated by application of the excitation light.

FIG. 7 is a graph indicating the relationship between heating temperatures in production steps of Examples 11 to 16 and purities of (6.5) and (8.7) chirality carbon nanotubes.

FIG. 8 is a three-dimensional fluorescence spectrum indicating the relationship between the wavelength of excitation light applied to a carbon nanotube composition obtained in Example 17 and a wavelength and intensity of fluorescence generated by application of the excitation light.

FIG. 9 is a three-dimensional fluorescence spectrum indicating the relationship between the wavelength of excitation light applied to a carbon nanotube composition obtained in Example 18 and a wavelength and intensity of fluorescence generated by application of the excitation light.

FIG. 10 is a three-dimensional fluorescence spectrum indicating the relationship between the wavelength of excitation light applied to a carbon nanotube composition obtained in Example 19 and a wavelength and intensity of fluorescence generated by application of the excitation light.

FIG. 11 is a three-dimensional fluorescence spectrum indicating the relationship between the wavelength of excitation light applied to a carbon nanotube composition obtained in Example 20 and a wavelength and intensity of fluorescence generated by application of the excitation light.

### DESCRIPTION OF EMBODIMENTS

Hereinafter, the present embodiments will be described in detail with appropriate reference to the drawings. In the drawings used in the following description, to make features of the present invention easy to understand, portions corresponding to the features are sometimes shown enlarged for the sake of convenience and the dimensional ratios and the like of components may differ from the actual ones. Materials, dimensions, and the like exemplified in the following description are examples, to which the present invention is not limited, and can be appropriately modified and implemented without departing from the spirit of the invention.

### (Carbon Nanotube Composition)

The carbon nanotube composition of the present embodiments includes a metal and carbon nanotubes.

The metal in the carbon nanotube composition is an alloy containing Ni, and both or one of Sn and/or Sb. That is, the metal may be any of a Ni—Sn alloy, a Ni—Sb alloy, and a Ni—Sn—Sb alloy. These alloys may further contain Fe. These alloys may be present in the carbon nanotube composition in the form of alloy particles. The alloy particles in the carbon nanotube composition can be a catalyst used in manufacturing the carbon nanotubes. At least one end of the carbon nanotubes may be adhered to surfaces of the alloy particles.

The alloy particle content in the carbon nanotube composition may be, for example, 1 or more per 100 carbon nanotubes. In addition, an average particle size of the alloy particles may be in a range of 1 nm or more and 50 nm or less. The content and average particle size of the alloy particles can be measured using, for example, a scanning transmission electron microscope-energy dispersive X-ray analyzer (STEM-EDX). The alloy particle content can be obtained by measuring a number of alloy particles adhered to 100 carbon nanotubes observed using STEM-EDX. The average particle size of the alloy particles can be obtained by calculating an average value of particle sizes of 100 alloy particles measured using STEM-EDX.

Ni content in the carbon nanotube composition may be 1 mass ppm or more. Sn content may be 1 mass ppm or more. Sb content may be 1 mass ppm or more. Fe content may be 1 mass ppm or more. Upper limits of the content of Ni, Sb, Sn and Fe are not particularly limited. For example, the total content of Ni, Sb, and Sn (when Fe is contained, the total content of Ni, Sb, Sn, and Fe) may be 30 mass % or less, 20 mass % or less, or 10 mass % or less. The content of these metals can be obtained by, for example, filtering a mixture of the carbon nanotube composition and an acid and measuring the content of the metals in the obtained filtrate using an ICP emission spectrometer.

In addition, the content of Ni, Sn, and Sb in the carbon nanotube composition may be amounts at which peaks of Ni and at least one of Sn or Sb are detected when elemental analysis by EDX is performed on a range including 100 or more carbon nanotubes. The range including 100 or more carbon nanotubes is, for example, 1 μm in terms of a spot diameter of EDX.

The carbon nanotubes are single-walled bodies and have semiconductivity. Examples of the semiconductive carbon nanotubes can include carbon nanotubes having chirality characteristics of (6.5), (7.5), (6,4), (7.3), (8,3), and (8.7).

The carbon nanotube composition of the present embodiments may selectively include (6.5) chirality carbon nanotubes having a chirality characteristic of (6.5). The (6.5) chirality carbon nanotubes of the carbon nanotube composition may have a purity of 60% or more, or 80% or more.

The carbon nanotube composition of the present embodiments may selectively include (8.7) chirality carbon nanotubes having a chirality characteristic of (8.7). The (8.7) chirality carbon nanotubes of the carbon nanotube composition may have a purity of 50% or more, 60% or more, or 80% or more.

The carbon nanotube composition of the present embodiments may selectively include (7.5) chirality carbon nanotubes having a chirality characteristic of (7.5). The (7.5) chirality carbon nanotubes of the carbon nanotube composition may have a purity of 60% or more, or 75% or more.

The content and purity of the respective chirality carbon nanotubes are values measured by fluorescence emission spectrometry which will be described below or values calculated by fitting a spectrum obtained by ultraviolet-visible-near infrared absorption spectrometry.

As an example, a method of measuring the content and purity of the (6.5) chirality carbon nanotubes by fluorescence emission spectrometry will be described.

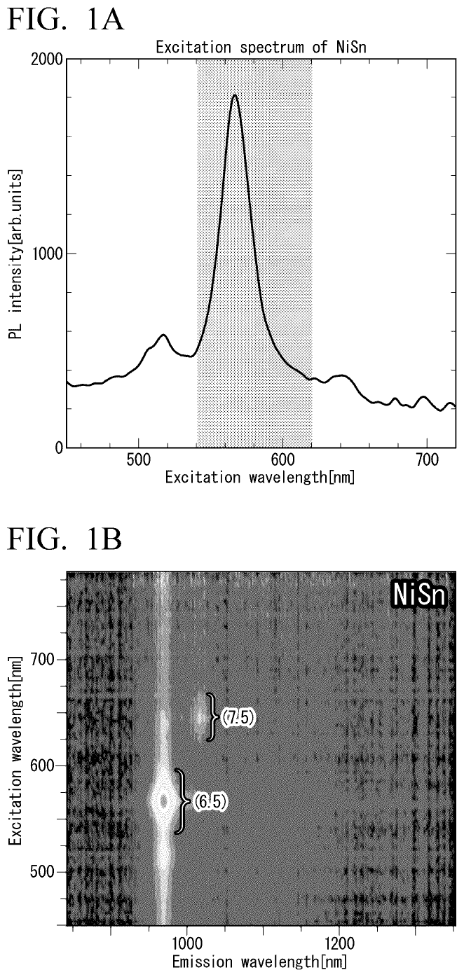

First, light (excitation light) is applied to the carbon nanotube composition, and the wavelength and intensity of light emission (fluorescence) generated when electrons in the carbon nanotubes return from an excited state to a ground state are measured. FIG. 1A is a fluorescence emission spectrum indicating the relationship between a wavelength of excitation light applied to a carbon nanotube composition obtained in Example 1 which will be described below and intensity of generated fluorescence at a wavelength of 970 nm. In the fluorescence emission spectrum of FIG. 1A, a peak at which the wavelength of the excitation light is in a range of from 540 to 620 nm represents a peak of fluorescence due to the (6.5) chirality carbon nanotubes. The fluorescence emission spectrum is measured while the wavelength of the excitation light is changed. For example, while the wavelength of the excitation light is changed in a range of from 450 to 750 nm at intervals of 4 nm, a fluorescence emission spectrum in a range of from 900 nm to 1450 nm is repeatedly measured, at intervals of 20 nm, with an InGaAs detector.

Next, a three-dimensional fluorescence spectrum indicating the relationship between the wavelength of the excitation light and the wavelength and intensity of the fluorescence is created from a plurality of fluorescence emission spectra obtained. FIG. 1B is a three-dimensional fluorescence spectrum indicating the relationship between the wavelength of excitation light applied to the carbon nanotube composition obtained in Example 1 which will be described below and a wavelength and intensity of fluorescence generated by application of the excitation light. In FIG. 1B, the horizontal axis represents a wavelength of the fluorescence, and the vertical axis represents a wavelength of the excitation light. The intensity of the fluorescence is indicated by shade of color. That is, the intensity of the fluorescence increases as the color becomes darker. In FIG. 1B, a region where the wavelengths of the excitation light are in the range of from 540 to 620 nm and the wavelengths of the fluorescence are in a range of from 950 to 1000 nm represents intensity of fluorescence due to the (6.5) chirality carbon nanotubes. Also, a region where the wavelengths of the excitation light are in a range of from 625 to 675 nm and the wavelengths of the fluorescence are in a range of from 1000 to 1050 nm represents intensity of fluorescence due to the (7.5) chirality carbon nanotubes.

The (6.5) chirality carbon nanotube content correlates with an integrated value (synthesis amount) I_{(6.5)} of the intensity of the fluorescence due to the (6.5) chirality carbon nanotubes. The (7.5) chirality carbon nanotube content correlates with an integrated value I_{(7.5)} of the intensity of the fluorescence due to the (7.5) chirality carbon nanotubes. Therefore, the purity (%) of the (6.5) chirality carbon nanotubes can be calculated by the following formula (1).

Purity (%)=I_{(6.5)}/(I_{(6.5)}+I_{(7.5)})×100 (1)

The carbon nanotube composition of the present embodiments may contain impurities. The impurities include, for example, a substance inevitably mixed from a raw material or a manufacturing process. Examples of the impurity include metals other than Ni, Sn, Sb, and Fe, and surfactants. The impurity content is, for example, 100 mass ppm or less. The impurity content may be 50 mass ppm or less, or may be 10 mass ppm or less.

The carbon nanotube composition of the present embodiments having the above-described configuration can be manufactured by a CVD method (chemical vapor deposition method) using alloy particles containing Ni, and both or one of Sn and/or Sb as a catalyst, and can contain a reduced amount of an impurity mixed in the manufacturing process, as compared with carbon nanotubes manufactured by a known separation method. In addition, the carbon nanotubes are single-walled bodies and have semiconductivity, and thus the carbon nanotube composition of the present embodiments can be advantageously used as, for example, a material for a transistor or a sensor or a coating type semiconductor.

When the metal is present in the form of particles in the carbon nanotube composition of the present embodiments, the metal particles can be removed by treating the carbon nanotube composition with an acid, and the purity of the carbon nanotube composition can be relatively easily increased. In addition, when the (6.5) chirality carbon nanotubes of the carbon nanotubes have a purity of 60% or more, the chirality characteristics of the carbon nanotubes are uniform, and thus the characteristics of transistors, sensors, and coating type semiconductors manufactured using the carbon nanotubes are easily stabilized.

### (Catalyst for Manufacturing Carbon Nanotubes)

The catalyst for manufacturing carbon nanotubes of the present embodiments is a catalyst for manufacturing carbon nanotubes having semiconductivity.

The catalyst of the present embodiments includes alloy particles containing Ni, and both or one of Sn and/or Sb. That is, the alloy particles may be any of Ni—Sn alloy particles. Ni—Sb alloy particles, and Ni—Sn—Sb alloy particles. The Ni content in the alloy particles may be in a range of 0.5 parts by mass or more and 10.0 parts by mass or less with respect to 1 part by mass of the total content of Sn and Sb. The Ni content with respect to 1 part by mass of the total content of Sn and Sb may be in a range of 0.5 parts by mass or more and 7.5 parts by mass or less or in a range of 0.5 parts by mass or more and 2.0 parts by mass or less.

The alloy particles may further contain Fe. The Fe content in the alloy particles may be in a range of 0.1 parts by mass or more and 5.0 parts by mass or less with respect to 1 part by mass of the total content of Sn and Sb. The Fe content with respect to 1 part by mass of the total content of Sn and Sb may be in a range of 0.5 parts by mass or more and 5.0 parts by mass or less, or in a range of 0.5 parts by mass or more and 2.0 parts by mass or less.

The alloy particles may be composite particles supported on porous particles. Examples of the porous particles include zeolite particles, magnesium oxide particles, silica particles, activated carbon, perlite, vermiculite, and diatomaceous earth.

When the porous particles are zeolite particles, examples of the backbone structure of the zeolite particles can include F type, A type, X type, and Y type, and the F type is preferable from the viewpoint of improving the chirality selectivity. Because the backbone structure of the zeolite particles supporting the alloy particles is the F type. (6.5) chirality carbon nanotubes can be selectively grown.

The alloy particle content in the composite particles may be, for example, in a range of 0.5 mass % or more and 10.0 mass % or less as the total content of Ni, Sn, Sb, and Fe. The alloy particle content may be in a range of 0.5 mass % or more and 5.0 mass % or less, or in a range of 1.0 mass % or more and 5.0 mass % or less. The content of Ni, Sn, Sb, and Fe in the porous particles are values obtained by filtering a mixture of the composite particles and an acid and measuring the content of the metals in the obtained filtrate.

An average particle size of the composite particles may be in a range of 500 nm or more and 10 μm or less. The average particle size of the alloy particles in the composite porous particles may be in a range of 1 nm or more and 50 nm or less. The average particle sizes of the composite particles and alloy particles can be measured using STEM-EDX. The average particle sizes of the composite particles and alloy particles are values obtained by calculating average values of particle sizes of 100 composite particles and 100 alloy particles measured using STEM-EDX.

A method of manufacturing composite particles will be described by taking the case where the alloy particles are Ni—Sn alloy particles as an example.

First, a nickel salt, a tin salt, and porous particles are added to a solvent to prepare a mixed dispersion in which the nickel salt and the tin salt are dissolved and the porous particles are dispersed. As the nickel salt and the tin salt, acetates can be used. The solvent is not particularly limited as long as it dissolves the nickel salt and the tin salt, and for example, a monohydric alcohol can be used.

Next, the obtained mixed dispersion is heated and dried while being stirred. A heating temperature of the mixed dispersion is, for example, a temperature equal to or higher than a boiling point of the solvent. The heating temperature of the mixed dispersion may be equal to or lower than the boiling point of the solvent+5° C. As a result, the nickel salt and tin salt dissolved in the mixed dispersion are precipitated on surfaces of the porous particles, and composite particles in which the alloy particles are supported on the surfaces of the porous particles are produced.

The catalyst of the present embodiments configured as described above contains Ni, and therefore acts as a catalyst for manufacturing carbon nanotubes. Further, since at least one of Sn or Sb is contained, the homogeneity of the chirality characteristics of the obtained carbon nanotubes is improved. When the Ni content is in the range of 0.5 parts by mass or more and 10.0 parts by mass or less with respect to 1 part by mass of the Sn or Sb content in the alloy particles, the (6.5) chirality carbon nanotubes can be produced more preferentially.

When the alloy particles further contain Fe, a production efficiency of the carbon nanotubes is improved. When the Fe content in the alloy particles is in the range of 0.1 parts by mass or more and 5.0 parts by mass or less with respect to 1 part by mass of the total content of Sn and Sb, a production efficiency of the (6.5) chirality carbon nanotubes is further improved.

When the alloy particles are supported on the porous particles, the alloy particles are less likely to aggregate. Therefore, by using the composite particles in which the alloy particles are supported on the porous particles, the production efficiency of the carbon nanotubes is further improved.

### (Method of Manufacturing Carbon Nanotubes)

The method of manufacturing carbon nanotubes of the present embodiments includes a preparation step of preparing a catalyst containing Ni and Sn or Sb, and a production step of producing carbon nanotubes by heating a carbon source in the presence of the catalyst. As the catalyst, the above-described catalyst for manufacturing carbon nanotubes can be used.

The carbon source used in the production step is a substance that supplies carbon atoms for forming carbon nanotubes. The carbon source may be a solid, a liquid, or a gas. As the solid and liquid carbon sources, for example, those which produce a gaseous carbon source by heating can be used. As the gaseous carbon source, for example, a carbon-containing gas such as an organic carbon-containing compound, carbon monoxide, or carbon dioxide can be used. The number of carbon atoms in the organic carbon-containing compound may be in a range of from 1 to 6. As the organic carbon-containing compound, for example, a hydrocarbon, an alcohol or a ketone can be used. The hydrocarbon may be a chain hydrocarbon or a cyclic hydrocarbon. Also, the hydrocarbon may be a saturated hydrocarbon or an unsaturated hydrocarbon. Further, in the hydrocarbon, a part or all of hydrogen atoms may be substituted with fluorine atoms.

In the production step, a heating temperature when the carbon source is heated in the presence of the catalyst may be, for example, 650° C. or lower. When the heating temperature is within the above range, the (6.5) chirality carbon nanotubes can be produced more preferentially.

The heating temperature when the carbon source is heated in the presence of the catalyst may be, for example, 700° C. or higher and 750° C. or lower. When the heating temperature is within the above range, the chirality selectivity changes from (6.5) to (8.7), and, as a result, (8.7) chirality carbon nanotubes can be produced more preferentially.

The production step may be performed using a plasma CVD method or a thermal CVD method.

For example, from the viewpoint of increasing the purity of the (6.5) chirality carbon nanotubes to be obtained, the production step is preferably carried out using the plasma CVD method. In the case of the plasma CVD method, the carbon nanotubes can be grown at a lower temperature than in the thermal CVD method, and, as a result, the purity of the (6.5) chirality carbon nanotubes can be increased more than in the thermal CVD method. A heating temperature in the plasma CVD method can be set to 475° C. or higher and 800° C. or lower (for example, 475° C.).

From the viewpoint of increasing the purity of the (8.7) chirality carbon nanotubes to be obtained, either the plasma CVD method or the thermal CVD method can be used, on the premise that the temperature range where the chirality selectivity is (8.7) is used.

The method of manufacturing carbon nanotubes of the present embodiments may further include an annealing step of annealing the carbon source in the presence of the catalyst after the preparation step and before the production step. The heating temperature at the time of annealing can be set to 20° C. or higher and 300° C. or lower (for example, 200° C.), and the heating time can be set to 0.1 hours or more and 3 hours or less (for example, 2 hours). The annealing step is preferably performed under reduced pressure, for example, in a vacuum.

By annealing the carbon source in the presence of the catalyst in the annealing step, the chirality selectivity of the carbon nanotubes to be obtained after the production step is changed from (6.5) to (7.5), and, as a result, (7.5) chirality carbon nanotubes can be produced more preferentially.

When the annealing step is performed, a composition ratio of the catalyst can be adjusted in the preparation step, from the viewpoint of further increasing the purity of the (7.5) chirality carbon nanotubes to be obtained. For example, when the catalyst is Ni—Sn—Fe alloy particles, when a mass ratio of Ni to a total mass of the Ni—Sn—Fe alloy particles is a, a mass ratio of Sn thereto is b, and a mass ratio of Fe thereto is c, the mass ratios can be adjusted and satisfy a<b<c.

When the annealing step is performed, the heating temperature can also be adjusted in the production step, from the viewpoint of further increasing the purity of the (7.5) chirality carbon nanotubes to be obtained. In this case, the heating temperature in the production step can be set to 475° C. or higher and 600° C. or lower (for example, 500° C.), and a heating time can be set to 0.5 minutes or more and 10 minutes or less (for example, 2 minutes).

The (7.5) chirality carbon nanotubes can be preferentially produced by (α) annealing (annealing step) before the production step, (β) annealing and adjusting the composition ratio of the catalyst in the preparation step, or (γ) annealing, adjusting the composition ratio of the catalyst in the preparation step, and adjusting the heating temperature in the production step, and the purity can be further increased.

In the production step, carbon nanotubes may be produced by heating the carbon source in the presence of the catalyst and porous particles. When the porous particles are zeolite particles, examples of the backbone structure of the zeolite particles can include F type, A type, X type, and Y type, and the F type is preferable from the viewpoint of improving the chirality selectivity. Because the backbone structure of the zeolite particles supporting the alloy particles is F type, Ni₃Sn is produced more preferentially, and carbon nanotubes having a specific chirality, for example, (6.5) chirality carbon nanotubes can be selectively grown.

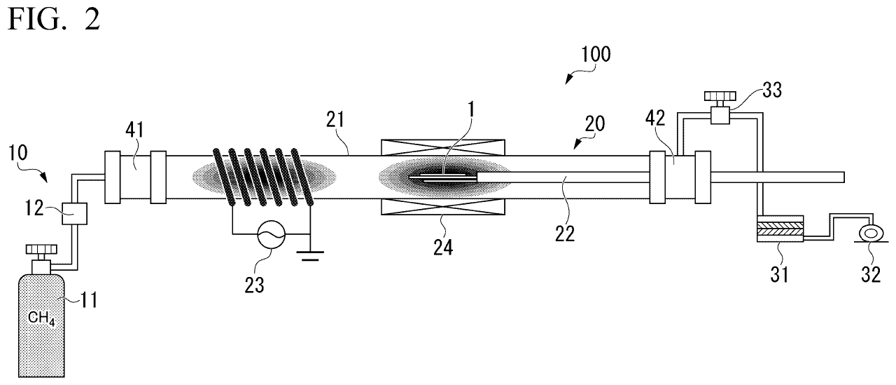

FIG. 2 is a configuration diagram of an example of a plasma CVD apparatus that can be used in the method of manufacturing carbon nanotubes of the present embodiments.

A plasma CVD apparatus 100 indicated in FIG. 2 includes a raw material gas supply unit 10, a reaction unit 20, and a pressure regulation unit 30. The raw material gas supply unit 10 is connected to one end of the reaction unit 20 via a first coupling portion 41. The pressure regulation unit 30 is connected to the other end of the reaction unit 20 via a second coupling portion 42.

The raw material gas supply unit 10 supplies a raw material gas to the reaction unit 20. The raw material gas supply unit 10 includes a carbon-containing gas tank 11 in which a carbon-containing gas serving as the raw material gas is stored. The carbon-containing gas tank 11 is connected to the first coupling portion 41 via a gas flow rate regulator 12. Note that the configuration of the raw material gas supply unit 10 is not limited to this. For example, the raw material gas supply unit 10 may include a supply apparatus of a dilution gas for diluting the carbon-containing gas. As the dilution gas, for example, hydrogen gas or nitrogen gas can be used.

The reaction unit 20 brings the raw material gas supplied from the reaction unit 20 into contact with a catalyst holding substrate 1 and causes the raw material gas to react with each other, thereby producing carbon nanotubes. The reaction unit 20 includes a reaction tube 21, a substrate supporting material member 22 for supporting the catalyst holding substrate 1 disposed inside the reaction tube 21, a plasma generator 23, and a heating furnace 24. The substrate supporting material member 22 is supported by the second coupling portion 42. The catalyst holding substrate 1 is a substrate having a catalyst layer including the above-described catalyst. The catalyst holding substrate 1 is fixed to a tip portion 22a of the substrate supporting material member 22. The plasma generator 23 is disposed on an outer periphery of the reaction tube 21 at a position between a position where the catalyst holding substrate 1 is disposed and the first coupling portion 41. The heating furnace 24 is disposed on the outer periphery of the reaction tube 21 at a position where the catalyst holding substrate 1 is disposed.

The pressure regulation unit 30 regulates the pressure in the reaction tube 21 of the reaction unit 20. The pressure regulation unit 30 includes a turbo pump 31 and a rotary pump 32. The turbo pump 31 is connected to the second coupling portion 42 via a valve. The rotary pump 32 is connected to the turbo pump 31.

The production of carbon nanotubes using the plasma CVD apparatus 100 is performed as follows.

First, the turbo pump 31 and the rotary pump 32 of the pressure regulation unit 30 are operated to regulate the pressure in the reaction tube 21 of the reaction unit 20. The pressure inside the reaction tube 21 is not particularly limited, and may be, for example, in a range of 1 Pa or more and 100 Pa or less. Further, the pressure inside the reaction tube 21 may be atmospheric pressure.

Next, in the raw material gas supply unit 10, the carbon-containing gas serving as the raw material gas is supplied to the reaction unit 20 using the gas flow rate regulator 12. A flow rate of the raw material gas supplied to the reaction unit 20 is, for example, in a range of 1 sccm or more and 100 sccm or less as the flow rate of the carbon-containing gas.

Next, in the reaction unit 20, the plasma generator 23 is operated to convert the raw material gas into plasma. Further, the heating furnace 24 is operated to heat the catalyst holding substrate 1. The temperature of the heating furnace 24 is, for example, in a range of 475° C. or higher and 750° C. or less. Then, the raw material gas converted into plasma is brought into contact with the catalyst layer of the heated catalyst holding substrate 1 to produce carbon nanotubes on a surface of the catalyst.

The produced carbon nanotubes can be recovered by peeling them off from the catalyst holding substrate 1. The recovered carbon nanotubes are typically carbon nanotube compositions to which the alloy particles of the catalyst are adhered.

According to the method of manufacturing carbon nanotubes of the present embodiments configured as described above, carbon nanotubes are produced using the above-described catalyst, and thus the (6.5) chirality carbon nanotubes, (8.7) chirality carbon nanotubes, or (7.5) chirality carbon nanotubes can be preferentially obtained. Further, in the method of manufacturing carbon nanotubes according to the present embodiments, since the raw material gas is converted into plasma, the production efficiency of the carbon nanotubes is improved. The raw material gas may be brought into contact with the catalyst holding substrate 1 without converting the raw material gas into plasma.

The carbon nanotubes obtained by the method of manufacturing carbon nanotubes of the present embodiments have a high purity of the (6.5) chirality carbon nanotubes, (8.7) chirality carbon nanotubes, or (7.5) chirality carbon nanotubes. Therefore, transistors, sensors, and coating type semiconductors manufactured by using the carbon nanotubes of the present embodiments are likely to have stable characteristics.

### EXAMPLES

### Example 1

A mixed dispersion was obtained by adding, to ethanol, 0.50 parts by mass of nickel acetate in terms of Ni amount, 0.50 parts by mass of tin acetate in terms of Sn amount, and 99.00 parts by mass of zeolite (type F, available from Tosoh Corporation, product name “HSZ-720KOA”). The obtained mixed dispersion was heated at a temperature of 85° C. and dried with stirring. The structure of the obtained dried product was analyzed using STEM-EDX. The metal content of the dried product was determined by measuring the content of metals in a filtrate obtained by filtering a mixture of the dried product and an acid using an ICP emission spectrometer. As a result, it was confirmed that the dried product was composite particles in which Ni—Sn alloy particles were supported on zeolite particles, that the Ni content was 0.50 mass %, and that the Sn content was 0.50 mass %.

Next, a carbon nanotube composition was manufactured using the obtained composite particles. The carbon nanotube composition was manufactured using the plasma CVD apparatus indicated in FIG. 2.

First, the composite particles were disposed on a substrate to prepare a catalyst holding substrate. The obtained catalyst holding substrate was disposed in a reaction unit of the plasma CVD apparatus. Next, a carbon nanotube composition was manufactured using methane gas as a raw material gas under the following conditions.
Internal diameter of reaction tube: 5 cm
RF power of plasma generator: 28 W
Distance between plasma generator and catalyst holding substrate: 40 cm
Temperature of heating furnace: 550° C.
Pressure inside reaction tube: 60 Pa
Flow rate of raw material gas: 20 sccm as flow rate of methane gas
Reaction time: 120 seconds

After completion of the manufacture, the catalyst holding substrate was taken out from the plasma CVD apparatus. The produced carbon nanotubes were peeled off from the catalyst holding substrate to recover a carbon nanotube composition. The recovered carbon nanotube composition and water were mixed: the obtained carbon nanotube composition dispersion was treated using a centrifugal separator; and the supernatant carbon nanotubes were recovered and dried to obtain a carbon nanotube composition.

### Example 2

Composite particles were manufactured in the same manner as in Example 1 except that 0.50 parts by mass of iron acetate in terms of Fe amount was further added to the mixed dispersion liquid and that the amount of zeolite was set to 98.50 parts by mass. A carbon nanotube composition was manufactured using the obtained composite particles. The obtained composite particles had a structure in which Ni—Sn—Fe alloy particles were supported on zeolite particles, and the Ni content was 0.50 mass %, the Sn content was 0.50 mass %, and the Fe content was 0.50 mass %.

### Example 3

Composite particles were manufactured in the same manner as in Example 2 except that the amounts of nickel acetate, tin acetate, and iron acetate were 0.75 parts by mass in terms of Ni amount, 0.10 parts by mass in terms of Sn amount, and 0.25 parts by mass in terms of Fe amount, respectively, and that the amount of zeolite was set to 98.90 parts by mass. A carbon nanotube composition was manufactured using the obtained composite particles. The obtained composite particles had a structure in which Ni—Sn—Fe alloy particles were supported on zeolite particles, and the Ni content was 0.75 mass %, the Sn content was 0.10 mass %, and the Fe content was 0.25 mass %.

### Example 4

Composite particles were manufactured in the same manner as in Example 3 except that the amount of tin acetate was set to 0.25 parts by mass in terms of Sn amount and that the amount of zeolite was set to 98.75 parts by mass, and a carbon nanotube composition was manufactured using the obtained composite particles. The obtained composite particles had a structure in which Ni—Sn—Fe alloy particles were supported on zeolite particles, and the Ni content was 0.75 mass %, the Sn content was 0.25 mass %, and the Fe content was 0.25 mass %.

### Example 5

Composite particles were manufactured in the same manner as in Example 3 except that the amount of tin acetate was set to 0.50 parts by mass in terms of Sn amount and that the amount of zeolite was set to 98.50 parts by mass, and a carbon nanotube composition was manufactured using the obtained composite particles. The obtained composite particles had a structure in which Ni—Sn—Fe alloy particles were supported on zeolite particles, and the Ni content was 0.75 mass %, the Sn content was 0.50 mass %, and the Fe content was 0.25 mass %.

### Example 6

Composite particles were manufactured in the same manner as in Example 2 except that the amounts of nickel acetate, tin acetate, and iron acetate were 1.50 parts by mass in terms of Ni amount, 1.50 parts by mass in terms of Sn amount, and 1.25 parts by mass in terms of Fe amount, respectively, and that the amount of zeolite was set to 95.75 parts by mass. A carbon nanotube composition was manufactured using the obtained composite particles. The obtained composite particles had a structure in which Ni—Sn—Fe alloy particles were supported on zeolite particles, and the Ni content was 1.50 mass %, the Sn content was 1.50 mass %, and the Fe content was 1.25 mass %.

### Comparative Example 1

Composite particles were manufactured in the same manner as in Example 1 except that neither tin acetate nor iron acetate was added, the amount of nickel acetate was set to 0.50 parts by mass in terms of Ni amount, and the amount of zeolite was set to 99.50 parts by mass; and a carbon nanotube composition was manufactured using the obtained composite particles. The obtained composite particles had a structure in which Ni particles were supported on zeolite particles, and the Ni content was 0.50 mass %.

### Comparative Example 2

Composite particles were manufactured in the same manner as in Example 1 except that neither nickel acetate nor iron acetate was added, the amount of tin acetate was set to 0.50 parts by mass in terms of Sn amount, and the amount of zeolite was set to 99.50 parts by mass; and a carbon nanotube composition was manufactured using the obtained composite particles. The obtained composite particles had a structure in which Sn particles were supported on zeolite particles, and the Sn content was 0.50 mass %.

### Comparative Example 3

Composite particles were manufactured in the same manner as in Example 1 except that neither nickel acetate nor tin acetate was added, the amount of iron acetate was set to 0.50 parts by mass in terms of Fe amount, and the amount of zeolite was set to 99.50 parts by mass; and a carbon nanotube composition was manufactured using the obtained composite particles. The obtained composite particles had a structure in which Fe particles were supported on zeolite particles, and the Fe content was 0.50 mass %.

For the carbon nanotube compositions obtained in Examples 1 to 6 and Comparative Examples 1 to 3, the content and purity of the (6.5) chirality carbon nanotubes, the presence or absence of the metal particles, the metal content, and the layer configurations were measured by the following methods. The results are indicated in Table 1.

### (Content and Purity of (6.5) Chirality Carbon Nanotubes)

Measurement was taken by fluorescence emission spectroscopy as described above. In the present Examples, since comparison is performed under the condition that the amount of the powder to be measured, the amount of the dispersion solution, the fluorescence measurement condition, and the like are all constant, the approximation of fluorescence intensity xx content is established. The (6.5) chirality carbon nanotube content is an integral value of the intensity of the fluorescence due to the (6.5) chirality carbon nanotubes.

### (Presence or Absence of Metal Particles, Composition, and Layer Configuration)

The layer structure of the carbon nanotubes was confirmed by observing 100 carbon nanotubes using STEM-EDX. Next, the particles adhered to the surfaces of the carbon nanotubes and having a particle size of 1 nm or more were subjected to elemental analysis using EDX to determine whether or not the particles were metal particles. The composition of the metal particles was analyzed using EDX. When the number of metal particles per 100 carbon nanotubes was 1 or more, the presence of metal particles was determined.

TABLE 1

| | | | | | Carbon nanotubes | | | | |
|---|---|---|---|---|---|---|---|---|---|
| | Composite particles (catalyst) | | | | (6,5) Chirality | | | | |
| | Metal particles | | | | carbon nanotubes | | Metal particles | | |
| | Ni | Sn | Fe | Zeolite | Content | Purity | Presence | | Layer |
| | (mass %) | (mass %) | (mass %) | Content | (count) | (%) | or absence | Composition | configuration |
| Example 1 | 0.50 | 0.50 | — | Remainder | 40034 | 84 | Present | Ni—Sn | Single-walled |
| Example 2 | 0.50 | 0.50 | 0.50 | Remainder | 280836 | 86 | Present | Ni—Sn—Fe | Single-walled |
| Example 3 | 0.75 | 0.10 | 0.25 | Remainder | 92891 | 55 | Present | Ni—Sn—Fe | Single-walled |
| Example 4 | 0.75 | 0.25 | 0.25 | Remainder | 99522 | 66 | Present | Ni—Sn—Fe | Single-walled |
| Example 5 | 0.75 | 0.50 | 0.25 | Remainder | 107043 | 76 | Present | Ni—Sn—Fe | Single-walled |
| Example 6 | 1.50 | 1.50 | 1.25 | Remainder | 289394 | 90 | Present | Ni—Sn—Fe | Single-walled |
| Comparative | 0.50 | — | — | Remainder | 26319 | 31 | Present | Ni | Single-walled |
| Example 1 | | | | | | | | | |

| | | | | | | | | |
|---|---|---|---|---|---|---|---|---|
| Comparative | — | 0.50 | — | Remainder | Not detected | Present | Sn | Single-walled |
| Example 2 | | | | | | | | |
| Comparative | — | — | 0.50 | Remainder | Not detected | Present | Fe | Single-walled |
| Example 3 | | | | | | | | |

From the results of Table 1, it was confirmed that the carbon nanotubes obtained in Examples 1 to 6 were carbon nanotube compositions including alloy particles containing: Ni and Sn or Ni, Sn, and Fe. In Examples 1 to 6 in which Ni—Sn alloy particles or Ni—Sn—Fe alloy particles were used as catalysts, the purities of the (6.5) chirality carbon nanotubes was improved, as compared with those in Comparative Examples 1 to 3 in which particles of each metal, i.e., Ni particles, Sn particles, and Fe particles were each used alone. In particular, it can be seen that the (6.5) chirality carbon nanotube content was increased in Examples 2 to 6 in which the Ni—Sn—Fe alloy particles were used, as compared with that in Example 1 in which the Ni—Sn alloy particles were used. From these results, it was confirmed that Sn contained in the catalyst has an effect of preferentially producing the (6.5) chirality carbon nanotubes, and Fe has an effect of increasing the amount of the (6.5) chirality carbon nanotubes produced.

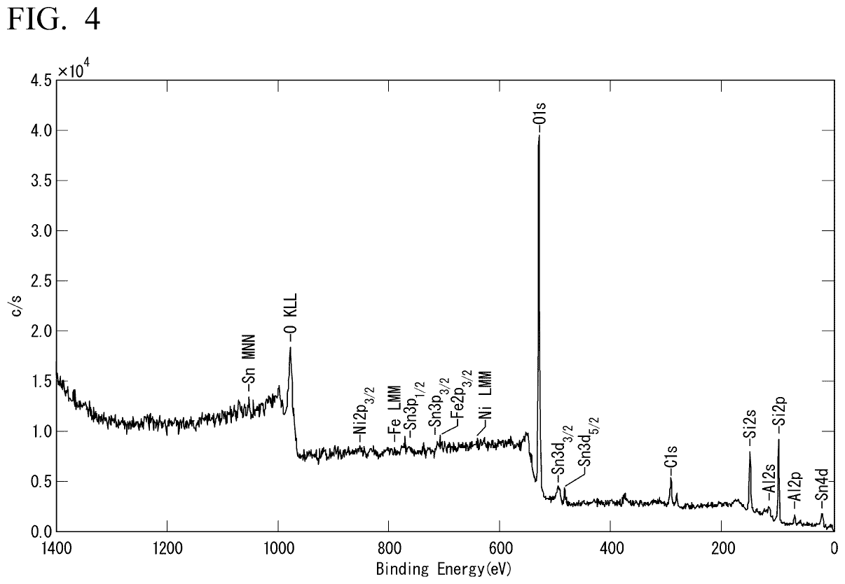

The carbon nanotube composition obtained in Example 2 was analyzed using an XPS apparatus (X-ray photoelectron spectrometer). The obtained X-ray photoelectron spectrum is indicated in FIG. 4. As a result of quantitative analysis of carbon, Fe, Ni, and Sn detected in the X-ray photoelectron spectroscopic spectrum using the XPS apparatus, the carbon content was 77.5 mass %, the F content was 4.6 mass %, the Ni content was 12.5 mass %, and the Sn content was 5.4 mass %.

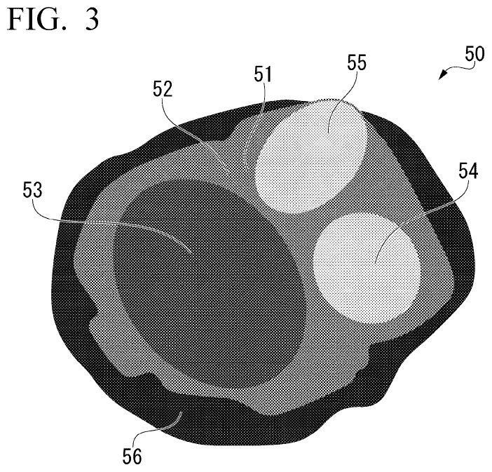

The structure of the metal particles contained in the carbon nanotube composition obtained in Example 2 was analyzed by crystal structure analysis using XRD, elemental analysis using EDX, and electron diffraction pattern analysis using STEM. The structure of the resulting metal particles is indicated in FIG. 3 as a conceptual diagram. As indicated in FIG. 3, metal particles 50 had a core-shell structure including a core portion 51 and a shell portion 56 covering the core portion 51. The core portion 51 had a sea-island structure in which a phase 53 (Ni+Fe:fcc-Ni) obtained by substituting a part of the Ni phase having a face-centered cubic lattice structure with Fe, a phase 54 (Ni+Sn:hcp-Ni) obtained by substituting a part of the Ni phase having a hexagonal close-packed structure with Sn, and a Ni₃Snₓ phase 55 including Ni₃Sn, Ni₃Sn₂, Ni₃Sn₄ and the like were dispersed in a Ni phase 52 having a face-centered cubic lattice structure (Ni:fcc-Ni phase). The shell portion 56 contained crystalline NiO and amorphous NiO. In addition, it was confirmed that, in the portion of the Ni₃Snₓ phase 55, the thickness of the shell portion 56 was reduced, or a part of the Ni₃Snₓ phase 55 was exposed. From this result, it is considered that the Ni₃Snₓ phase 55 has an effect of preferentially growing the carbon nanotubes and attaining the (6.5) chirality.

### Example 7

A carbon nanotube composition was manufactured in the same manner as in Example 2 except that the temperature of the heating furnace was set to 500° C. The obtained carbon nanotubes had (6.5) chirality carbon nanotube content of 1962 counts and a purity of 77.2%.

### Example 8

A carbon nanotube composition was manufactured in the same manner as in Example 2, except that, before the raw material gas was supplied to the reaction tube, the temperature of the heating furnace was set to 550° C., the catalyst holding substrate was heated for 2 minutes, then the temperature of the heating furnace was set to 500° C., and then the raw material gas was supplied to the reaction tube. The obtained carbon nanotubes had an amount of the (6.5) chirality carbon nanotubes produced of 95484 counts and a purity of 96.1%. By performing the pretreatment of heating the catalyst at 550° C., the purity was improved even when the heating temperature at the time of producing the carbon nanotubes was set to 475° C. which was lower than 500° C.

### Example 9

A mixed dispersion was obtained by adding, to ethanol, Nickel acetate in a proportion of 0.50 parts by mass in terms of Ni amount, antimony acetate in a proportion of 0.50 parts by mass in terms of Sb amount, and zeolite in a proportion of 99.00 parts by mass. The obtained mixed dispersion was heated at a temperature of 85° C. with stirring and dried in the same manner as in Example 1 to obtain composite particles. The obtained composite particles had a structure in which Ni—Sb alloy particles were supported on zeolite particles, and had Ni content of 0.50 mass % and Sb content of 0.50 mass %.

A carbon nanotube composition was manufactured, in the same manner as in Example 1, using the obtained composite particles. The obtained carbon nanotubes were carbon nanotube compositions including Ni—Sb alloy particles. The carbon nanotubes were single-walled bodies, and had a purity of the (6.5) chirality carbon nanotubes of 87%, and the (6.5) chirality carbon nanotube content of 53923 counts. The Ni—Sb alloy particles, like the Ni—Sn alloy particles, were confirmed to be useful for manufacturing semiconductive carbon nanotubes including (6.5) chirality carbon nanotubes.

### Example 10

Composite particles and a carbon nanotube composition were manufactured in the same manner as in Example 2, except that, before the production step, annealing was performed at a methane gas flow rate of 20 sccm, a pressure inside the reaction tube of 60 Pa, a heating furnace temperature of 550° C., and a reaction time of 120 seconds (annealing step), and, during the production step, heating was performed at an RF power of a plasma generator of 50 W and a heating furnace temperature of 475° C. A three-dimensional fluorescence spectrum indicating the relationship between the wavelength of excitation light applied to the carbon nanotube composition obtained in Example 10 and the wavelength and intensity of fluorescence generated by application of the excitation light, is indicated in FIG. 5.

The metal particles in the obtained composite particles were Ni—Sn—Fe alloy particles containing Ni₃Sn, and the obtained carbon nanotubes had the (6.5) chirality carbon nanotube content of 16800 counts and a purity of 96%.

### Examples 11 to 16

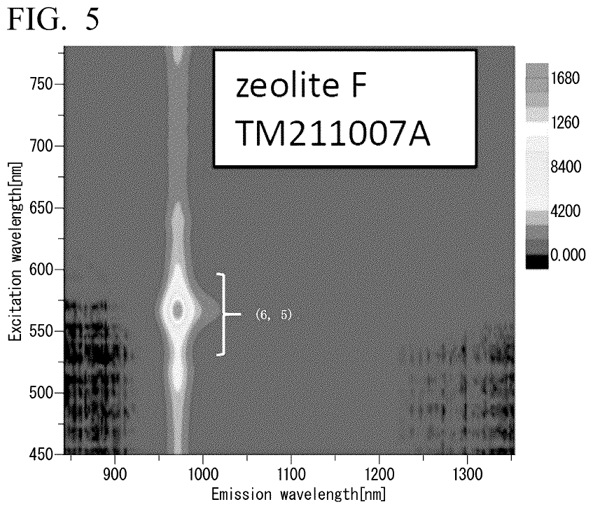

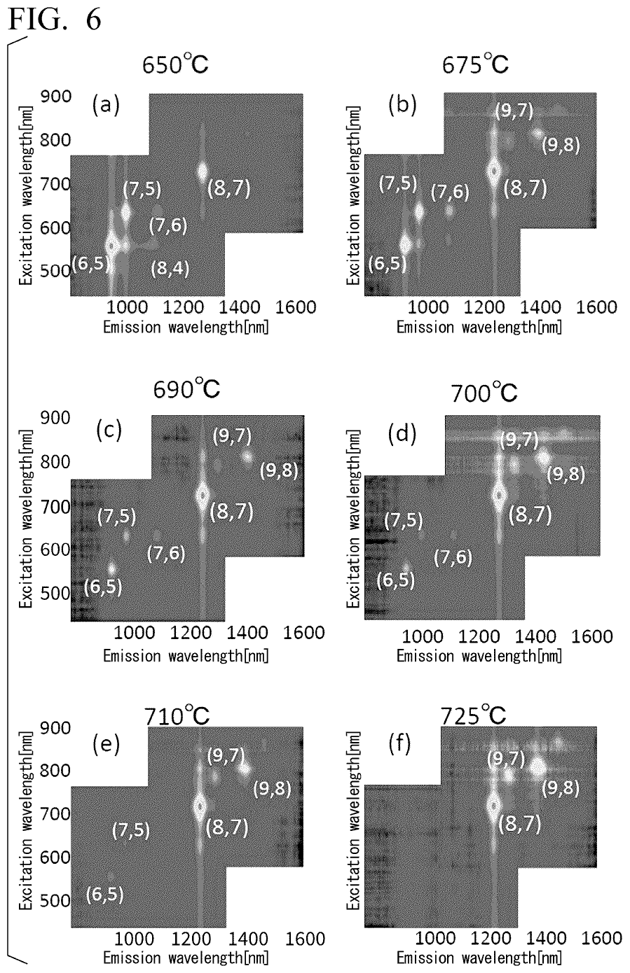

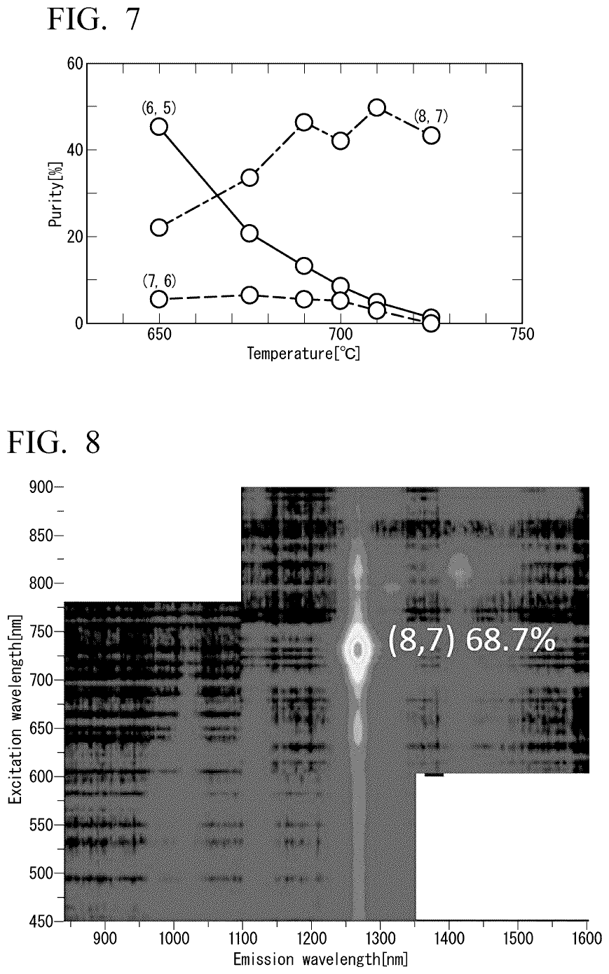

Composite particles and carbon nanotube compositions were manufactured in the same manner as in Example 2, except that the heating furnace was heated at temperatures of 650° C., 675° C., 690° C. 700° C., 710° C., and 725° C. during the production step. Three-dimensional fluorescence spectra indicating the relationship between the wavelength of excitation light applied to the carbon nanotube compositions obtained in Examples 11 to 16 and the wavelength and intensity of fluorescence generated by application of the excitation light, are indicated in FIGS. 6(a) to 6(f). The relationship between the heating temperature in the production step and the purities of the (6.5) and (8.7) chirality carbon nanotubes is indicated in FIG. 7.

All of the metal particles in the composite particles obtained in Examples 11 to 16 were Ni—Sn—Fe alloy particles containing Ni₃Sn. It was also confirmed that, when the synthesis temperature was increased to 700° C. or higher, the chirality selectivity was changed from (6.5) to (8.7), and that the purity of the (8.7) chirality carbon nanotubes was increased. It is presumed that this is because the (8,8) chirality carbon nanotubes grow from Ni₃Sn (0001), then its chirality selectivity is changed to (8.7) which is (n,n−1), and, as a result, the (8.7) chirality carbon nanotubes are preferentially produced.

### Example 17

Composite particles and a carbon nanotube composition were manufactured in the same manner as in Example 2, except that a thermal CVD apparatus was used and that the following conditions were set. A three-dimensional fluorescence spectrum indicating the relationship between the wavelength of excitation light applied to the carbon nanotube composition obtained in Example 17 and the wavelength and intensity of fluorescence generated by application of the excitation light, is indicated in FIG. 8.
Temperature inside chamber: 700° C.
Pressure inside chamber: 60 Pa
Flow rate of raw material gas: 20 sccm as flow rate of methane gas
Reaction time: 120 seconds

The metal particles in the composite particles obtained in Example 17 were Ni—Sn—Fe alloy particles containing Ni₃Sn. The amount of the (8.7) chirality carbon nanotubes produced was 9150 counts, and the purity was 68.7%. It was confirmed that the purity of the (8.7) chirality carbon nanotubes can be increased by synthesis at a heating temperature of 700° C. or higher using a thermal CVD method instead of the plasma CVD method.

### Example 18

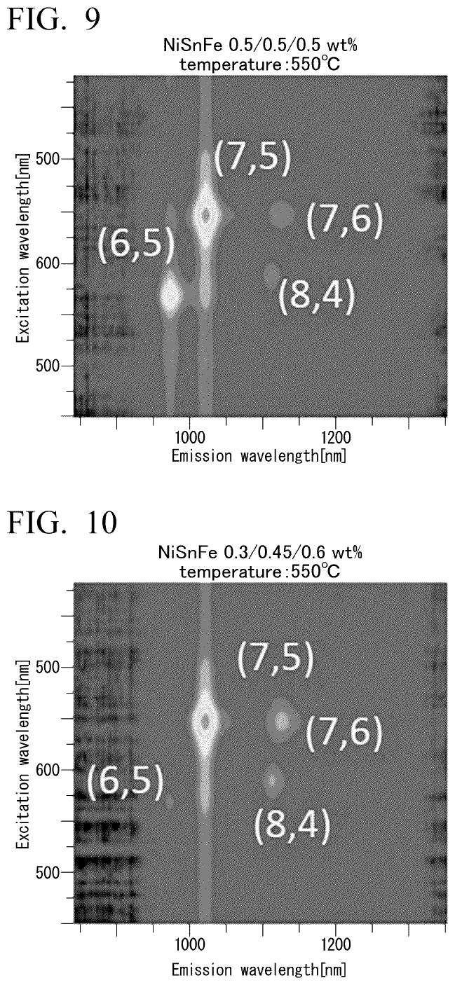

Composite particles and a carbon nanotube composition were manufactured in the same manner as in Example 2, except that annealing was performed in vacuum at a heating temperature of 200° C. for 3 hours before the production step. A three-dimensional fluorescence spectrum indicating the relationship between the wavelength of excitation light applied to the carbon nanotube composition obtained in Example 18 and the wavelength and intensity of fluorescence generated by application of the excitation light, is indicated in FIG. 9.

The metal particles in the composite particles obtained in Example 18 were Ni—Sn—Fe alloy particles containing Ni₃Sn. The amount of the (7.5) chirality carbon nanotubes produced was 34000 counts, and the purity was 60.1%. It was confirmed that, when the annealing was performed before the production step, the chirality selectivity was changed from (6.5) to (7.5), and that the purity of the (7.5) chirality carbon nanotubes was increased.

### Example 19

Composite particles and a carbon nanotube composition were manufactured in the same manner as in Example 18, except that, in the preparation step, the raw materials were adjusted so that the composite particles had Ni content of 0.3 mass %, Sn content of 0.45 mass %, and Fe content of 0.6 mass %. A three-dimensional fluorescence spectrum indicating the relationship between the wavelength of excitation light applied to the carbon nanotube composition obtained in Example 19 and the wavelength and intensity of fluorescence generated by application of the excitation light, is indicated in FIG. 10.

The metal particles in the composite particles obtained in Example 19 were Ni—Sn—Fe alloy particles containing Ni₃Sn. The amount of the (7.5) chirality carbon nanotubes produced was 14700 counts, and the purity was 72.5%. It was confirmed that the purity of the (7.5) chirality carbon nanotubes was further increased by adjusting the raw materials so that the relationship of the mass ratio magnitude was (Ni content)<(Sn content)<(Fe content) in the preparation step, and then performing annealing.

### Example 20

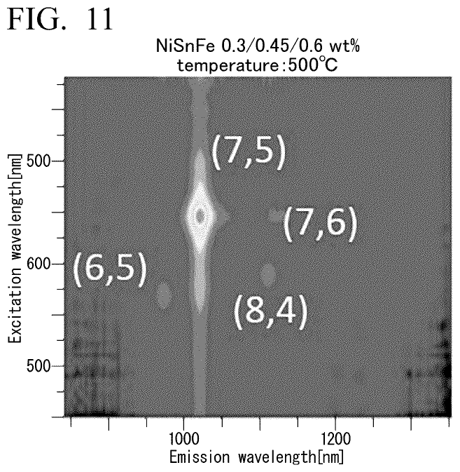

Composite particles and carbon nanotube compositions were manufactured in the same manner as in Example 19, except that the heating furnace was heated at a temperature of 500° C. during the production step. A three-dimensional fluorescence spectrum indicating the relationship between the wavelength of excitation light applied to the carbon nanotube composition obtained in Example 20 and the wavelength and intensity of fluorescence generated by application of the excitation light, is presented in FIG. 11.

The metal particles in the composite particles obtained in Example 20 were Ni—Sn—Fe alloy particles containing Ni₃Sn. The amount of the (7.5) chirality carbon nanotubes produced was 7880 counts, and the purity was 79.9%. It was confirmed that the purity of the (7.5) chirality carbon nanotubes was further increased by adjusting the raw materials so that the relationship of the mass ratio magnitude was (Ni content)<(Sn content)<(Fe content) in the preparation step, then performing annealing, and further lowering the synthesis temperature.

### REFERENCE SIGNS LIST

1: Catalyst holding substrate
10: Raw material gas supply unit
11: Carbon-containing gas tank
12: Gas flow rate regulator
20: Reaction unit
21: Reaction tube
22: Substrate supporting material
22a: Tip portion
23: Plasma generator
24: Heating furnace
30: Pressure regulation unit
31: Turbo pump
32: Rotary pump
41: First coupling portion
42: Second coupling portion
50: Metal particle
51: Core portion
52: Ni phase with face-centered cubic lattice structure
53: Phase in which part of Ni phase with face-centered cubic lattice structure is substituted with Fe
54: Phase in which part of Ni phase with hexagonal close-packed structure is substituted with Sn
55: Ni₃Snₓ phase
56: Shell portion
100: Plasma CVD apparatus

1. A carbon nanotube composition comprising a metal and a carbon nanotube, the metal comprising Ni, and both or one of Sn and/or Sb, the carbon nanotube being a single-walled body and having semiconductivity.

2. The carbon nanotube composition according to claim 1, wherein the metal is present in a form of particles, and at least one end of the ends of the carbon nanotube is adhered to a surface of the particles.

3. The carbon nanotube composition according to claim 1, comprising 1 mass ppm or more of Ni, and 1 mass ppm or more of both or one of Sn and/or Sb.

4. The carbon nanotube composition according to claim 1, wherein the carbon nanotube comprises a (6.5) chirality carbon nanotube, and the (6.5) chirality carbon nanotube has a purity of 60% or more.

5. The carbon nanotube composition according to claim 1, wherein the carbon nanotube comprises a (8.7) chirality carbon nanotube, and the (8.7) chirality carbon nanotube has a purity of 60% or more.

6. The carbon nanotube composition according to claim 1, wherein the carbon nanotube comprises a (7.5) chirality carbon nanotube, and the (7.5) chirality carbon nanotube has a purity of 60% or more.

7. A catalyst for manufacturing carbon nanotubes, the catalyst comprising alloy particles comprising Ni, and both or one of Sn and/or Sb.

8. The catalyst for manufacturing carbon nanotubes according to claim 7, wherein Ni content with respect to 1 part by mass of total content of Sn and Sb in the alloy particles is in a range of 0.5 parts by mass or more and 10.0 parts by mass or less.

9. The catalyst for manufacturing carbon nanotubes according to claim 7, wherein the alloy particles further comprises Fe.

10. The catalyst for manufacturing carbon nanotubes according to claim 9, wherein Fe content with respect to 1 part by mass of total content of Sn and Sb in the alloy particles is in a range of 0.1 parts by mass or more and 5.0 parts by mass or less.

11. The catalyst for manufacturing carbon nanotubes according to claim 7, wherein the alloy particles are supported on porous particles.

12. A method of manufacturing carbon nanotubes, the method comprising: a preparation step of preparing a catalyst comprising Ni, and both or one of Sn and/or Sb; and a production step of producing carbon nanotubes by heating a carbon source in a presence of the catalyst.

13. The method of manufacturing carbon nanotubes according to claim 12, wherein, in the production step, a heating temperature when the carbon source is heated in the presence of the catalyst is 650° C. or lower.

14. The method of manufacturing carbon nanotubes according to claim 12, wherein, in the production step, a heating temperature when the carbon source is heated in the presence of the catalyst is 700° C. or higher and 750° C. or lower.

15. The method of manufacturing carbon nanotubes according to claim 12, further comprising, after the preparation step and before the production step, an annealing step of annealing the carbon source in the presence of the catalyst.

16. The method of manufacturing carbon nanotubes according to claim 12, wherein, in the production step, the carbon source is a carbon-containing gas, and the carbon-containing gas is converted into plasma and brought into contact with the catalyst.

17. The method of manufacturing carbon nanotubes according to claim 12, wherein, in the production step, the carbon nanotubes are produced by heating the carbon source in the presence of the catalyst and porous particles.

18. A carbon nanotube obtained by the method described in claim 12.
